(19) United States
(12) Patent Application Publication
(10) Pub. No.: US 2013/0290702 A1
(43) Pub. Date: Oct. 31, 2013

(54) METHOD, DEVICE, AND SYSTEM FOR ACQUIRING ENCRYPTED INFORMATION BASED ON WIRELESS ACCESS

(71) Applicant: Huawei Technologies Co., Ltd., Shenzhen (CN)

(72) Inventor: Gang Wang, Shanghai (CN)

(21) Appl. No.: 13/848,527

(22) Filed: Mar. 21, 2013

(30) Foreign Application Priority Data
Mar. 21, 2012 (CN) 201210075785.X

(51) Int. Cl. H04W 12/08

(52) U.S. Cl. CPC H04W 12/08
USPC 713/155

(57) ABSTRACT

A method, device, and system for acquiring encrypted information based on wireless access are disclosed in embodiments of the present invention, which are applied to the field of communications technologies. In the embodiments of the present invention, encrypted information is preset in an AP. When receiving a first access request sent by a terminal device and used for requesting access to a network, the AP verifies the terminal device. If the verification is successful, the AP schedules the preset encrypted information and sends the preset encrypted information to the terminal device. In this way, the AP sends the encrypted information to the terminal device only after the terminal device initiating the access request is successfully verified.

### CROSS-REFERENCE TO RELATED APPLICATIONS

This application claims priority to Chinese Patent Application No. 201210075785.X, filed on Mar. 21, 2012, which is hereby incorporated by reference in its entirety.

### FIELD OF THE INVENTION

The present invention relates to the field of communications technologies, and in particular, to a method, device, and system for acquiring encrypted information based on wireless access.

### BACKGROUND OF THE INVENTION

In a wireless network, some wireless communication devices, such as wireless fidelity (wireless fidelity, WIFI) wireless routers or handheld WIFI devices, have functions of a wireless access point (Access Point, AP). The devices may be referred to as APs for short, and other wireless communication devices may access the network for communication through an AP.

To enable a terminal device to access an AP securely, the terminal device needs to access the AP in an encryption manner, that is, encrypted information needs to be carried in an access request sent by the terminal device to the AP, so that the AP restricts an access route of the terminal device according to the encrypted information. The encrypted information needs to be agreed on by a user of the AP and a user of the terminal device in advance. In this way, the encrypted information is easily leaked, which is insecure.

### SUMMARY OF THE INVENTION

Embodiments of the present invention provide a method, device, and system for acquiring encrypted information based on wireless access, thereby improving the security of encrypted information for wireless access.

An embodiment of the present invention provides a method for acquiring encrypted information based on wireless access, where the method includes:

receiving a first access request sent by a terminal device and used for requesting access to a network, and verifying the terminal device;

if the verification is successful, invoking encrypted information for wireless access, where the encrypted information for wireless access is preset in an access point; and

sending, to the terminal device, the invoked encrypted information for wireless access.

An embodiment of the present invention provides an access point, including:

a request receiving unit, configured to receive a first access request sent by a terminal device and used for requesting access to a network;

a verification unit, configured to verify the terminal device;

an invocation unit, configured to: when the verification unit verifies the terminal device successfully, invoke encrypted information for wireless access, where the encrypted information for wireless access is preset in the access point; and

an information sending unit, configured to send, to the terminal device, the encrypted information for wireless access, where the encrypted information for wireless access is invoked by the invocation unit.

An embodiment of the present invention provides a communication system, including a terminal device and an access point, where

the terminal device is configured to send to the access point a first access request used for requesting access to a network and receive encrypted information returned by the access point; and the access point includes:

a request receiving unit, configured to receive the first access request sent by the terminal device and used for requesting access to the network;

a verification unit, configured to verify the terminal device after the request receiving unit receives the first access request sent by the terminal device;

an invocation unit, configured to: when the verification unit verifies the terminal device successfully, invoke encrypted information for wireless access, where the encrypted information for wireless access is preset in the access point; and

an information sending unit, configured to send, to the terminal device, the encrypted information for wireless access, where the encrypted information for wireless access is invoked by the invocation unit.

In the embodiments of the present invention, the encrypted information is preset in the AP. When receiving the first access request sent by the terminal device and used for requesting access to the network, the AP verifies the terminal device. If the verification is successful, the AP schedules the preset encrypted information and sends the preset encrypted information to the terminal device, so that the AP sends the encrypted information to the terminal device only after the terminal device initiating the access request is successfully verified. Compared with the prior art in which users need to agree on the encrypted information, the method in the embodiment does not easily leak the encrypted information, thereby improving the security of the encrypted information.

### BRIEF DESCRIPTION OF THE DRAWINGS

To illustrate the technical solutions in the embodiments of the present invention or in the prior art more clearly, the accompanying drawings required for describing the embodiments or the prior art are briefly introduced in the following. Apparently, the accompanying drawings in the following description merely show some embodiments of the present invention, and persons of ordinary skill in the art may still derive other drawings from these accompanying drawings without creative efforts.

FIG. 1 is a flow chart of a method for acquiring encrypted information based on wireless access according to an embodiment of the present invention;

FIG. 2 is a schematic structural diagram of an access point according to an embodiment of the present invention; and

FIG. 3 is a schematic structural diagram of another access point according to an embodiment of the present invention.

### DETAILED DESCRIPTION OF THE EMBODIMENTS

The technical solutions in the embodiments of the present invention are clearly and completely described in the following with reference to the accompanying drawings in the embodiments of the present invention. Apparently, the embodiments to be described are merely a part rather than all of the embodiments of the present invention. All other embodiments obtained by persons of ordinary skill in the art based on the embodiments of the present invention without creative efforts shall fall within the protection scope of the present invention.

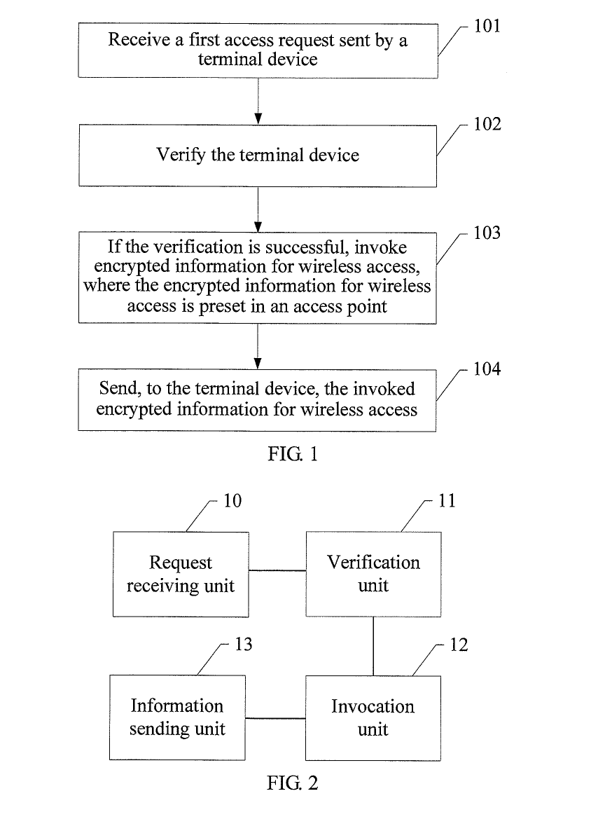

An embodiment of the present invention provides a method for acquiring encrypted information based on wireless access. The method is applied for a terminal device to acquire encrypted information for wireless access from an AP in a process that the terminal device accesses a network through the AP. The method executed by the AP is shown in FIG. 1 and includes the following steps:

Step 101: Receive a first access request sent by the terminal device and used for requesting access to a network.

It should be understood that, if a terminal device needs to access a network, for example, a long term evolution (Long Term Evolution, LTE) network or a second generation or third generation communication technology (2G/3G) network, the terminal device may send a first access request to an AP of a corresponding network and access the corresponding network through the AP. In this embodiment, the first access request may include information such as an identifier of the terminal device, but does not include encrypted information, that is, the terminal device needs to access the AP in a non-encryption manner (open none) to acquire the encrypted information.

Step 102: Verify the terminal device; if the verification is successful, execute step 103; and if the verification is unsuccessful, restrict the access of the terminal device to the network, and end the process.

After receiving the first access request, the AP needs to verify the terminal device. For example, the AP compares identification information of the terminal device included in the first access request with identification information preset in the AP; if the identification information of the terminal device included in the first access request matches the identification information preset in the AP, the verification is successful and step 103 is executed. The AP may also perform the verification in other manners, and the present invention is not limited to a specific verification method.

Further, after the AP receives the first access request, if a network access manner set in the AP is a non-encryption manner, the terminal device may not be verified, and the terminal device may directly access the network; if the network access manner set in the AP is an encryption manner, step 102 needs to be executed.

Step 103: Invoke encrypted information for wireless access, where the encrypted information for wireless access is preset in the access point. The encrypted information refers to security information for the terminal device to access the network through the AP, may include information such as a service set identifier (Service Set Identifier, SSID) or a security key (Security Key), and may also include information such as an encryption manner.

Step 104: Send, to the terminal device, the invoked encrypted information for wireless access.

The AP may edit the encrypted information to make it be a shot message, and send the encrypted information to the terminal device through the short message, so that the terminal device may access the AP and then access the network in the encryption manner. Specifically, the terminal device sends a second access request carrying the encrypted information to the AP, where the second access request is used for requesting access to the network. When receiving the second access request that is sent by the terminal device and carries the encrypted information, the AP compares the encrypted information carried in the second access request with the encrypted information preset in the AP. If the encrypted information carried in the second access request matches the encrypted information preset in the AP, the AP enables the terminal device to access the network. If the encrypted information carried in the second access request does not match the encrypted information preset in the AP, the AP restricts the access of the terminal device to the network.

It is obvious that, in the embodiment of the present invention, when the encrypted information is preset in the AP and when the AP receives the first access request sent by the terminal device, the AP verifies the terminal device. If the verification is successful, the AP schedules the preset encrypted information and sends the preset encrypted information to the terminal device. In this way, the AP sends the encrypted information to the terminal device only after the terminal device initiating the first access request is successfully verified. Compared with the prior art in which users need to agree on the encrypted information, the method in this embodiment does not easily leak the encrypted information, thereby improving the security of the encrypted information.

In a specific embodiment, the AP may execute step 102 by executing the following steps. The steps are as follows:

A: Send prompt information to the terminal device or a third-party terminal device, where the prompt information is used for prompting for content information to be sent to the access point. For example, the prompt information may prompt a user to send information such as a phone number of a friend or the birthday of a friend to the AP. Further, a user interface may be set on the AP, and a user may set the content information through the interface. In this situation, the user may use a third-party device (for example, a cell phone) or the terminal device to send the specific content information to the AP, and the specific content information may be sent through a short message. The AP may provide the prompt information through a hypertext markup language (Hypertext Markup Language, HTML) page.

B: Receive information that is sent by the terminal device or the third-party terminal device according to the prompt information, and if the received information matches content preset in the AP, the verification is successful.

When receiving the information sent according to the prompt information, the AP compares the received information with the preset content. For example, the AP compares the birthday of a friend with the birthday of a friend stored in the AP, or compares the phone number of a friend with a phone number of a friend stored in the AP. If the received information matches the preset content, the verification is successful. If the received information does not match the preset content, the verification is unsuccessful.

In another specific embodiment, a user interface may be set in the AP, and the user sets the encrypted information for wireless access through the user interface. Specifically, the user may trigger the AP by operating a button or a touchscreen of the AP, so that the AP provides the user with a setting interface used for setting the encrypted information for wireless access. The user may modify the encrypted information or add information to the encrypted information in the setting interface, and the AP stores the encrypted information received form the setting interface as a file. Specifically, the encrypted information received form the setting interface may be stored in a file such as an extensible markup language (Extensible Markup Language, XML) file in a flash.

In another specific embodiment, the user may trigger the display of the encrypted information by operating a button or the touchscreen of the AP. Specifically, after receiving a display command used for displaying the encrypted information, the AP invokes the encrypted information preset in the AP and displays the encrypted information in an interface of the AP. During the display, the AP may use a light-emitting diode (Light-Emitting Diode, LED) or an organic LED for displaying. In this way, if the user forgets the encrypted information for wireless access, the encrypted information may be displayed by operating the button or the touchscreen of the AP.

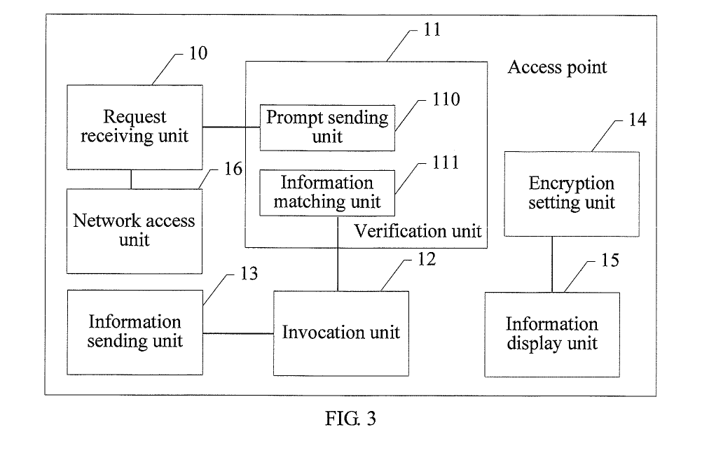

An embodiment of the present invention also provides an access point, and a schematic structural diagram thereof is shown in FIG. 2. The access point includes:

a request receiving unit 10, configured to receive a first access request sent by a terminal device and used for requesting access to a network;

a verification unit 11, configured to verify the terminal device after the request receiving unit 10 receives the first access request, where the verification unit 11 may compare an identifier of the terminal device with an identifier preset in the AP, so as to verify the terminal device;

an invocation unit 12, configured to: when the verification unit 11 verifies the terminal device successfully, invoke encrypted information for wireless access, where the encrypted information for wireless access is preset in the access point; and

an information sending unit 13, configured to send, to the terminal device, the encrypted information for wireless access, where the encrypted information for wireless access is invoked by the invocation unit 12. The information sending unit 13 may send the invoked encrypted information to the terminal device through a short message.

In the access point of the embodiment of the present invention, when the request receiving unit 10 receives the first access request sent by the terminal device and used for requesting access to the network, the verification unit 11 verifies the terminal device. If the verification is successful, the invocation unit 12 schedules the preset encrypted information, and the information sending unit 13 sends the encrypted information to the terminal device. In this way, the AP sends the encrypted information to the terminal device only after the terminal device initiating the first access request is successfully verified. Compared with the prior art in which users need to agree on the encrypted information, the embodiment of the present invention does not easily leak the encrypted information, thereby improving the security of the encrypted information.

Referring to FIG. 3, in a specific embodiment, apart from the structure shown in FIG. 2, the access point may further include: an encryption setting unit 14, an information display unit 15, and a network access unit 16. The verification unit 11 may specifically include: a prompt sending unit 110 and an information matching unit 111.

The prompt sending unit 110 is configured to send prompt information to the terminal device or a third-party terminal device, where the prompt information is used for prompting for content information to be sent to the access point.

The information matching unit 111 is configured to receive information that is sent by the terminal device or the third-party terminal device according to the prompt information, where the verification is successful if the received information matches content preset in the access point.

The encryption setting unit 14 is configured to provide a user with a setting interface used for setting the encrypted information for wireless access and store the encrypted information received from the setting interface as a file.

The information display unit 15 is configured to receive a display command used for displaying the encrypted information, invoke the encrypted information preset in the access point, and display the encrypted information.

The network access unit 16 is configured to: when encrypted information carried in a second access request received by the request receiving unit 10 matches the encrypted information preset in the access point, enables the terminal device to access the network, where the second access request is used for requesting access to the network.

In the access point of this embodiment, when the request receiving unit 10 receives the first access request, if the access request does not carry the encrypted information, the prompt sending unit 110 in the verification unit 11 may send the prompt information, where the prompt information is used for prompting for the content information to be sent to the access point. When the user sends corresponding content to the access point through the third-party terminal device or the terminal device, the information matching unit 111 compares the corresponding content with the content preset in the access point after receiving the corresponding content. If the corresponding content matches the content preset in the access point, the verification is successful, and the information sending unit 13 sends the encrypted information invoked by the invocation unit 12. If the corresponding content does not match the content preset in the access point, the verification is unsuccessful, and the information matching unit 111 may send the information for indicating that the verification is unsuccessful to the terminal device. After acquiring the encrypted information, the terminal device may send the second access request carrying the encrypted information to the access point. When the request receiving unit 10 receives the encrypted information carried in the second access request, the network access unit 16 enables the terminal device to access the network if the encrypted information is consistent with the encrypted information preset in the AP. If the carried encrypted information is inconsistent with the encrypted information preset in the AP, the network access unit 16 may restrict the access of the terminal device to the network, and may return the information for indicating that the encrypted information is inconsistent with the encrypted information preset in the AP to the terminal device.

In this embodiment, the AP may provide the user with the setting interface used for setting the encrypted information for wireless access through the encryption setting unit 14, and store the encrypted information received from the setting interface as a file, thereby setting the encrypted information. After receiving the display command used for displaying the encrypted information, the information display unit 15 displays the encrypted information set through the encryption setting unit 14. In this way, the user may send the display command used for displaying the encrypted information to the access point by operating a button or a touchscreen of the access point.

An embodiment of the present invention also provides a communication system, including a terminal device and an access point, where

the terminal device is configured to send to the access point a first access request used for requesting access to a network and receive encrypted information returned by the access point; and

the access point is configured to receive the first access request sent by the terminal device and used for requesting access to the network, and verify the terminal device; and if the verification is successful, invoke encrypted information for wireless access, where the encrypted information for wireless access is preset in the access point, and send, to the terminal device, the invoked encrypted information for wireless access.

After receiving the encrypted information returned by the access point, the terminal device may send a second access request carrying the encrypted information to the access point, where the second access request is used for requesting access to the network. In this way, the access point compares the encrypted information carried in the second access request with the encrypted information preset in the access point. If the encrypted information carried in the second access request matches the encrypted information preset in the access point, the access point enables the terminal device to access the network. If the encrypted information carried in the second access request is inconsistent with the encrypted information preset in the access point, the access point restricts the access of the terminal device to the network.

The access point in this embodiment may be the access point shown in FIG. 2 or FIG. 3, which is not described herein again.

Persons of ordinary skill in the art may understand that all or a part of the steps of the methods according to the embodiments may be implemented by a program instructing relevant hardware. The program may be stored in a computer readable storage medium, which may be a read only memory (ROM), a random access memory (RAM), a magnetic disk, or a CD-ROM.

The foregoing describes the method, device, and system for acquiring encrypted information based on wireless access provided by the embodiments of the present invention in detail. The principle and implementation of the present invention are explained herein through specific examples. The description of the foregoing embodiments is merely provided for ease of understanding of the method and the core ideas of the present invention. Persons of ordinary skill in the art can make variations to the present invention in terms of the specific implementations and application scopes according to the ideas of the present invention. Therefore, the specification shall not be constructed as a limit to the present invention.

What is claimed is:

1. A method for acquiring encrypted information based on wireless access, comprising:
receiving a first access request sent by a terminal device and used for requesting access to a network, and verifying the terminal device;
if the verification is successful, invoking encrypted information for wireless access, wherein the encrypted information for wireless access is preset in an access point; and
sending, to the terminal device, the invoked encrypted information for wireless access.

2. The method according to claim 1, wherein the verifying the terminal device specifically comprises:
sending prompt information to the terminal device or a third-party terminal device, wherein the prompt information is used for prompting for content information to be sent to the access point; and
receiving information that is sent by the terminal device or the third-party terminal device according to the prompt information, wherein if the received information matches content preset in the access point, the verification is successful.

3. The method according to claim 1, wherein the sending, to the terminal device, the invoked encrypted information for wireless access specifically comprises:
sending the invoked encrypted information to the terminal device through a short message.

4. The method according to claim 1, wherein before the receiving the first access request sent by the terminal device and used for requesting access to the network, the method further comprises:
providing the user with a setting interface used for setting the encrypted information for wireless access, and storing the encrypted information received from the setting interface as a file.

5. The method according to claim 4, further comprising:
receiving a display command used for displaying the encrypted information, invoking the encrypted information preset in the access point, and displaying the encrypted information.

6. The method according to claim 1, further comprising:
receiving a second access request that is sent by the terminal device and carries the encrypted information, wherein the second access request is used for requesting access to the network, and if the encrypted information carried in the second access request matches the encrypted information preset in the access point, enabling the terminal device to access the network.

7. An access point, comprising:
a request receiving unit, configured to receive a first access request sent by a terminal device and used for requesting access to a network;
a verification unit, configured to verify the terminal device after the request receiving unit receives the first access request sent by the terminal device;
an invocation unit, configured to: when the verification unit verifies the terminal device successfully, invoke encrypted information for wireless access, wherein the encrypted information for wireless access is preset in the access point; and
an information sending unit, configured to send, to the terminal device, the encrypted information for wireless access, wherein the encrypted information for wireless access is invoked by the invocation unit.

8. The access point according to claim 7, wherein the verification unit specifically comprises:
a prompt sending unit, configured to send prompt information to the terminal device or a third-party terminal device, wherein the prompt information is used for prompting for content information to be sent to the access point; and
an information matching unit, configured to receive information that is sent by the terminal device or the third-party terminal device according to the prompt information, wherein the verification is successful if the received information matches content preset in the access point.

9. The access point according to claim 7, further comprising:
an encryption setting unit, configured to provide a user with a setting interface used for setting the encrypted information for wireless access, and store the encrypted information received from the setting interface as a file.

10. The access point according to claim 9, further comprising:
an information display unit, configured to receive a display command used for displaying the encrypted information, invoke the encrypted information preset in the access point, and display the encrypted information.

11. The access point according to claim 7, wherein
the request receiving unit is further configured to receive a second access request that is sent by the terminal device and carries the encrypted information, wherein the second access request is used for requesting access to the network; and
the access point further comprises a network access unit, configured to enable the terminal device to access the network when the encrypted information carried in the second access request received by the request receiving unit matches the encrypted information preset in the access point.
